(19) United States
(12) Patent Application Publication
(10) Pub. No.: US 2014/0147270 A1
(43) Pub. Date: May 29, 2014

(54) Aircraft Nacelle Comprising A Reinforced Connection Between An Air Intake And A Means Of Propulsion

(71) Applicant: AIRBUS OPERATIONS SAS, TOULOUSE (FR)

(72) Inventors: Alain Porte, Colomiers (FR); Stéphane Dida, Fontenilles (FR)

(73) Assignee: AIRBUS OPERATIONS SAS, TOULOUSE (FR)

(21) Appl. No.: 14/084,691

(22) Filed: Nov. 20, 2013

(30) Foreign Application Priority Data
Nov. 23, 2012 (FR) 12 61170

(51) Int. Cl. B64D 33/02

(52) U.S. Cl. CPC B64D 33/02
USPC 415/214.1

(57) ABSTRACT

An aircraft nacelle includes an air intake, connected to a means of propulsion, which defines a longitudinal direction, an outer wall, an inner duct including an annular flange connected, by means of connecting elements, to the means of propulsion, and a forward frame and a rear frame which connects the outer wall and the inner duct.

The rear frame includes a first ring and a second ring, in longitudinal planes. The rings include a first connection to the outer wall. The first ring includes a second connection with the annular flange. The second ring includes a third connection with the inner duct. The third connection is remote from the second connection.

### FIELD OF THE INVENTION

The present invention relates to an aircraft nacelle comprising a reinforced connection between an air intake and a means of propulsion.

### BACKGROUND OF THE INVENTION

An aircraft propulsion assembly comprises a nacelle wherein is arranged, substantially concentrically, a means of propulsion connected to the rest of the aircraft by means of a pylon.

As shown in FIG. 1, the nacelle comprises, at the front, an air intake 10 by means of which an air flow can be channelled towards the means of propulsion 12, wherein a first portion of the inflowing air, termed the primary flow, passes through the means of propulsion in order to participate in combustion, and the second portion of the air flow, termed the secondary flow, is driven by a fan and flows in an annular duct delimited by the inner wall of the nacelle and the outer wall of the means of propulsion.

For the remainder of the description, the longitudinal direction corresponds to the direction of the axis of rotation of the fan of the means of propulsion.

The air intake 10 comprises a lip 14; that surface of the lip which is in contact with the aerodynamic flows extends, inside the nacelle, in the form of an inner duct 16 of substantially circular section and, outside the nacelle, in the form of an outer wall 18 of substantially circular section. The means of propulsion comprises a duct 20 which may be arranged in the continuation of the inner duct 16.

As shown in FIG. 2, the air intake 10 is connected to the means of propulsion 12 by a connection which comprises, at the level of the means of propulsion, a first annular flange 22 secured to a second annular flange 24 of a panel which delimits the duct 16 or of an interposed part 26, termed bracket, connected to the panel which delimits the duct 16. The two flanges 22 and 24 are clamped against one another, at the level of a junction plane 28 which is substantially perpendicular to the longitudinal direction, and are held in that position by connecting elements 30, for example bolts or rivets, which pass through the flanges 22, 24 and extend parallel to the longitudinal direction.

In terms of structure, the air intake 10 comprises a first frame, termed the forward frame 32, which connects the inner duct 16 and the outer wall 18 delimiting, with the lip 14, an annular duct 34 and a second frame, termed the rear frame 36, which connects the inner duct 16 and the outer wall 18 close to the junction plane 28.

The rear frame, for its part, transmits bending, rotational or other forces which act on the air intake such as, for example, the weight of the air intake and the forces produced by the aerodynamic flows.

According to one embodiment, the rear frame 36 is connected to the duct 16 either directly or via an interposed part or bracket 38 (shown in detail in FIG. 2) one leg of which is connected to the duct 16, the other leg being connected to the rear frame 36.

The rear frame 36 is connected to the outer wall 18 either directly or via a bracket 40 (shown in FIG. 1) having a T-shaped cross section, wherein the rear frame 36 is connected at the level of the foot of the T-shaped bracket, and wherein the head of the T presses against the inner face of the outer wall 18.

In accordance with one embodiment shown in the document FR-2.904.604, the rear frame comprises a first metal ring, in particular made of titanium, which extends around the entire periphery and which is connected to the inner duct 16, and a second ring whose outer peripheral edge is connected to the outer wall 18. The first ring comprises, at the level of its outer peripheral edge, a region overlapping the inner peripheral edge of the second ring. The two rings are connected by any appropriate means at the level of this overlapping region.

In the event of fan blades failing, the duct 20 of the means of propulsion tends to undergo substantial deformation as it is designed to absorb, by deformation, the energy of the broken blades. At the level of the air intake, the inner duct 16 is made of a composite material and its mechanical properties are more limited than those of the duct 20 of the means of propulsion, in particular in terms of bending strength.

In addition, in order to limit the risks of the panel or panels, which form the inner duct 16 of the air intake, coming loose, it is expedient to limit the propagation of the deformations from the duct 20 of the means of propulsion towards the inner duct 16 of the air intake.

A first solution consists in designing a rear frame and/or a connection between the air intake and the means of propulsion which may deform so as to absorb a portion of the energy and thus limit the propagation of the deformations towards the inner duct 16 of the air intake.

Another solution consists in limiting the deformations of the inner duct 16 of the air intake by stiffening it in the connection region between the inner duct 16 of the air intake and the duct of the means of propulsion. Solutions have been developed for increasing the stiffness of the rear frame or of the connection between the air intake and the means of propulsion.

In order to stiffen the connection between the air intake and the means of propulsion, one solution consists in increasing the thickness of the flanges, increasing the number of connecting elements or increasing the size of the latter. However, this solution is not satisfactory as it increases the on-board mass.

In order to stiffen the rear frame, the document FR-2.960.856 proposes a reinforced rear frame comprising a first metal ring whose inner edge is connected to the inner wall of the air intake and a second ring whose outer edge is connected to the outer wall of the air intake, the two rings being connected to each other. According to one feature of this rear frame, the second ring comprises at least one angular sector made of composite material having at least one hollow shape and the first ring comprises a rib extending over the entire periphery of said ring.

Whichever region is stiffened (rear frame or connection between the air intake and the means of propulsion), there is a risk of deformation by torsion between the annular flange of the air intake and the rest of the inner duct, it being possible for a bending movement, along an axis tangential to the inner duct, to appear between the annular flange and the rest of the duct when the duct of the means of propulsion undergoes deformation.

Another drawback is that the rear frames of the prior art are not entirely satisfactory in terms of axial (in the longitudinal direction) and radial stiffness. BRIEF SUMMARY OF THE INVENTION

Thus, the present invention aims to remedy the drawbacks of the prior art.

To that end, the an embodiment of the invention is an aircraft nacelle comprising:
an air intake, connected to a means of propulsion, which defines a longitudinal direction,
an outer wall,
an inner duct comprising an annular flange connected, by means of connecting elements, to the means of propulsion,
a forward frame and a rear frame which connects the outer wall and the inner duct,
   said nacelle being characterized in that the rear frame comprises a first ring and a second ring, in longitudinal planes, said rings comprising a first connection to the outer wall, the first ring comprising a second connection with the annular flange, the second ring comprising a third connection with the inner duct, which third connection is remote from the second connection.

That the second and third connections are remote from one another makes it possible to limit the risk of the connection between the air intake and the means of propulsion becoming deformed by limiting bending phenomena between the annular flange and the rest of the inner duct.

The rear frame preferably comprises a reinforcing element which connects the two rings and maintains the separation between them in the longitudinal direction, said reinforcing element being remote from the outer wall and from the inner duct.

The presence of the reinforcing element makes it possible to stiffen the two rings and to increase the axial and radial rigidity of the rear frame as well as the strength of the connection between the air intake and the means of propulsion with respect to circumferential forces.

### BRIEF DESCRIPTION OF THE DRAWINGS

Other features and advantages will become apparent from the following purely exemplary description of the invention with regard to the appended drawings, in which:

FIG. 1 is a cutaway of the lower, forward portion of an aircraft nacelle according to the prior art,

FIG. 2 is a cutaway showing, in detail, a connection between an air intake and a means of propulsion according to the prior art,

FIG. 3A is a longitudinal cutaway showing, in detail, a rear frame according to a first embodiment of the invention,

FIG. 3B is a longitudinal cutaway showing, in detail, a rear frame according to a second embodiment of the invention,

FIG. 4A is a longitudinal cutaway showing, in detail, a rear frame according to a third embodiment of the invention,

FIG. 4B is a longitudinal cutaway showing, in detail, a rear frame according to a fourth embodiment of the invention,

FIG. 5 is a longitudinal cutaway showing, in detail, a rear frame according to a fifth embodiment of the invention,

FIG. 6 is a longitudinal cutaway showing, in detail, a rear frame according to a sixth embodiment of the invention, and

FIG. 7 is a longitudinal cutaway showing, in detail, a rear frame according to a seventh embodiment of the invention.

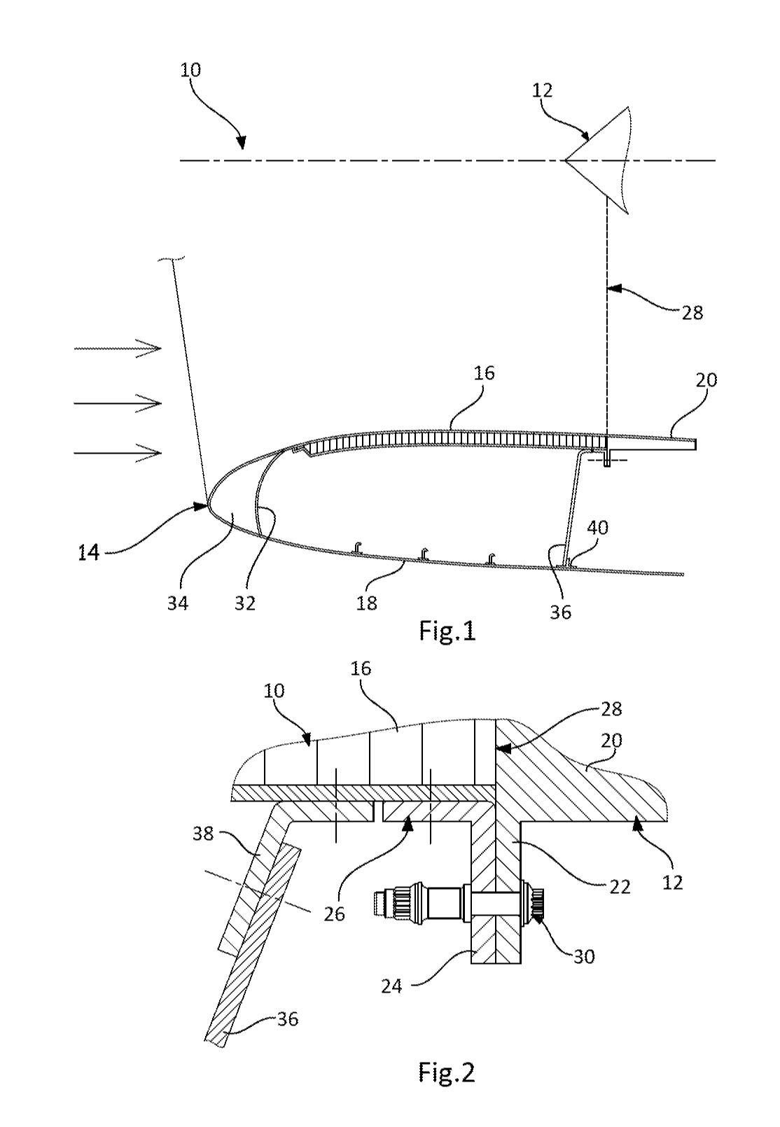

### DETAILED DESCRIPTION

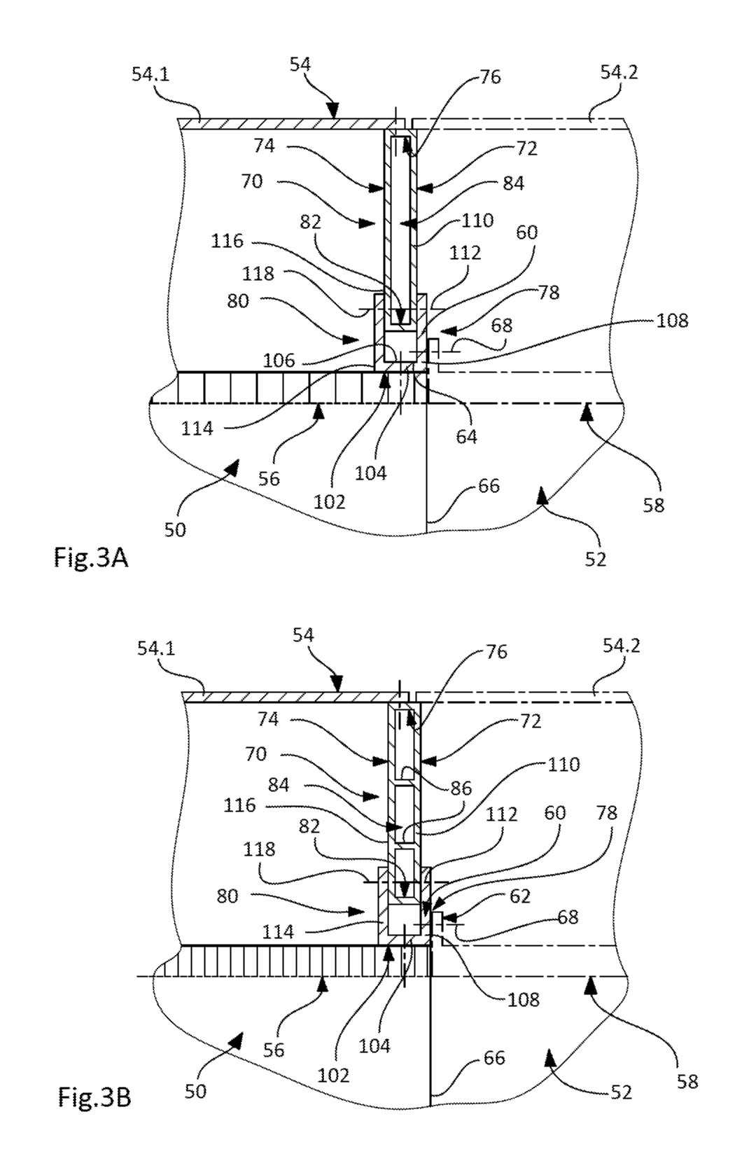

FIGS. 3A, 3B, 4A, 4B and 5 to 7 show a portion of an aircraft nacelle. As in the prior art, it comprises at the front an air intake 50 by means of which a flow of air can be channelled towards a means of propulsion 52.

The air intake 50 comprises at the front a lip; that surface of the lip which is in contact with the aerodynamic flows extends, outside the nacelle, in the form of an outer wall 54 and, inside the nacelle, in the form of an inner duct 56. The means of propulsion 52 comprises a duct 58 which may be arranged in the continuation of the inner duct 56.

According to one embodiment, the inner duct 56 is delimited by a panel for acoustic treatment which comprises, from the centre of the nacelle outwards, an acoustically resistive layer, at least one cellular structure and a reflective layer.

As shown in the various figures, the outer wall 54 of the nacelle comprises several panels 54.1, 54.2 which are juxtaposed with their edge faces meeting. Some panels 54.1 are fixed and others 54.2 can be moved, so as to allow access to the interior of the nacelle. The inner duct 56 and the outer wall 54 are not described in more detail as they can be in accordance with the prior art.

For the present application, a longitudinal plane corresponds to a plane containing the longitudinal direction. A transverse plane is a plane which is perpendicular to the longitudinal direction. A radial direction is a direction which is perpendicular to the longitudinal direction.

A surface is referred to as an outer surface if it is oriented toward the exterior of the nacelle.

The air intake 50 is connected to the means of propulsion 52 by a connection comprising a first annular flange 60 at the level of the air intake and a second annular flange 62 at the level of the means of propulsion.

According to a first embodiment, this first annular flange 60 is manufactured as a single part with a part forming at least one portion of the inner duct 56.

According to another embodiment, shown for example in FIG. 5, the first annular flange 60 is a wing of an interposed part 64, also termed a bracket, connected to a panel forming the inner duct 56.

Each annular flange 60 or 62 extends in a plane which is substantially perpendicular to the longitudinal direction.

The ends of the ducts 56 and 58 are clamped against one another, at the level of a junction plane 66 which is substantially perpendicular to the longitudinal direction, and are held in that position by connecting elements 68, for example bolts or rivets, which extend parallel to the longitudinal direction and which are distributed over the circumference of the two ducts 56 and 58.

According to one known embodiment, the connecting elements 68 pass through the annular flanges 60 and 62 and keep them clamped against one another.

The connecting elements 68 are not described in more detail as they can be identical to those of the prior art and be arranged in the same way.

In terms of structure, the air intake 50 comprises a first frame, termed the forward frame (not shown) and a second frame, termed the rear frame 70, which connects the outer wall 54 of the nacelle and the inner duct 56 in a region close to the junction plane 66.

According to an embodiment of the invention, the rear frame 70 comprises a first ring 72 and a second ring 74, in longitudinal planes, said rings 72 and 74 comprising a first connection 76 to the outer wall 54, the first ring 72 comprising a second connection 78 with the first annular flange 60, the second ring 74 comprising a third connection 80 with the inner duct 56, which third connection is remote from the second connection 78. The rear frame 70 comprises a reinforcing element 82 which connects the two rings 72 and and maintains the separation between them in the longitudinal direction, said reinforcing element 82 being remote from the outer wall 54 and from the inner duct 56.

According to an embodiment of the invention, a connection is understood as a junction between two elements which transmits forces between the two elements.

That the two connections 78 and 80 are remote from one another makes it possible to limit the risk of the connection between the air intake and the means of propulsion undergoing deformation by limiting bending phenomena between the annular flange 60 and the rest of the inner duct 56.

The presence of the reinforcing element 82 makes it possible to stiffen the two rings and to increase the axial and radial rigidity of the rear frame as well as the strength of the connection between the air intake and the means of propulsion with respect to circumferential forces.

Thus, according to an embodiment of the invention, the first ring 72 transmits forces between the first connection 76 and the second connection 78 while the second ring 74 transmits forces between the first connection 76 and the third connection 80.

The first ring 72 and the second ring 74 are preferably connected at the level of the outer wall 54. Thus, the first ring 72, the second ring 74 and the reinforcing element 82 form a torsion box.

Advantageously, in order to improve the transmission of axial forces, the reinforcing element 82 is parallel to the longitudinal direction, and the distance between the reinforcing element and the inner duct 56 is less than the distance between the reinforcing element and the outer wall 54.

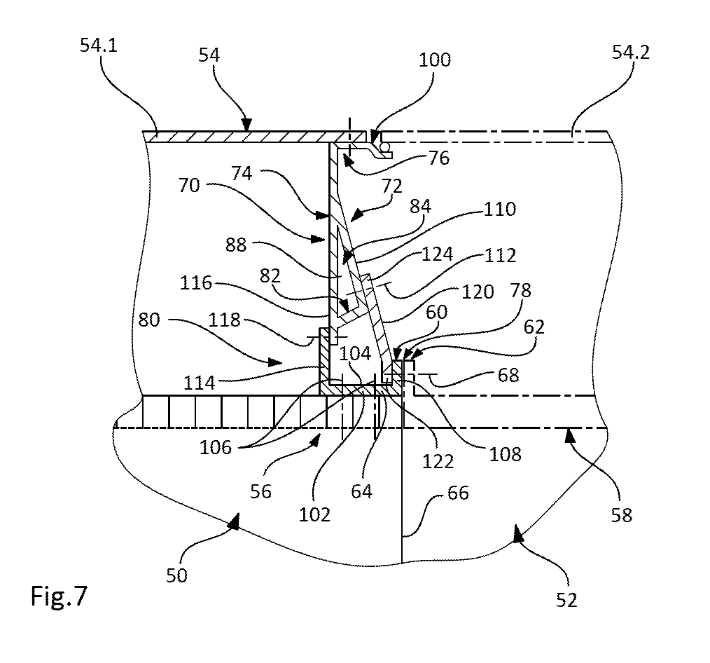

As a variant, it is possible for the reinforcing element 82 not to be parallel to the longitudinal direction, as shown in FIG. 7. In this case, that end of the reinforcing element 82 which is connected to the second ring is closer to the inner duct 56 than that end of the reinforcing element 82 which is connected to the first ring 72.

The two rings 72, 74 and the reinforcing element 82 can extend over the entire circumference of the nacelle or only over certain angular sectors. Depending on the embodiment, the first connection 76 can extend over the entire circumference of the outer wall 54, or only over certain angular sectors, and can be either continuous, such as a welded seam, or pointwise, such as rivets or bolts.

In parallel, the connections 78 and 80 can extend over the entire circumference of the inner duct 56, or only over certain angular sectors, and can be either continuous, such as a welded seam, or pointwise, such as rivets or bolts.

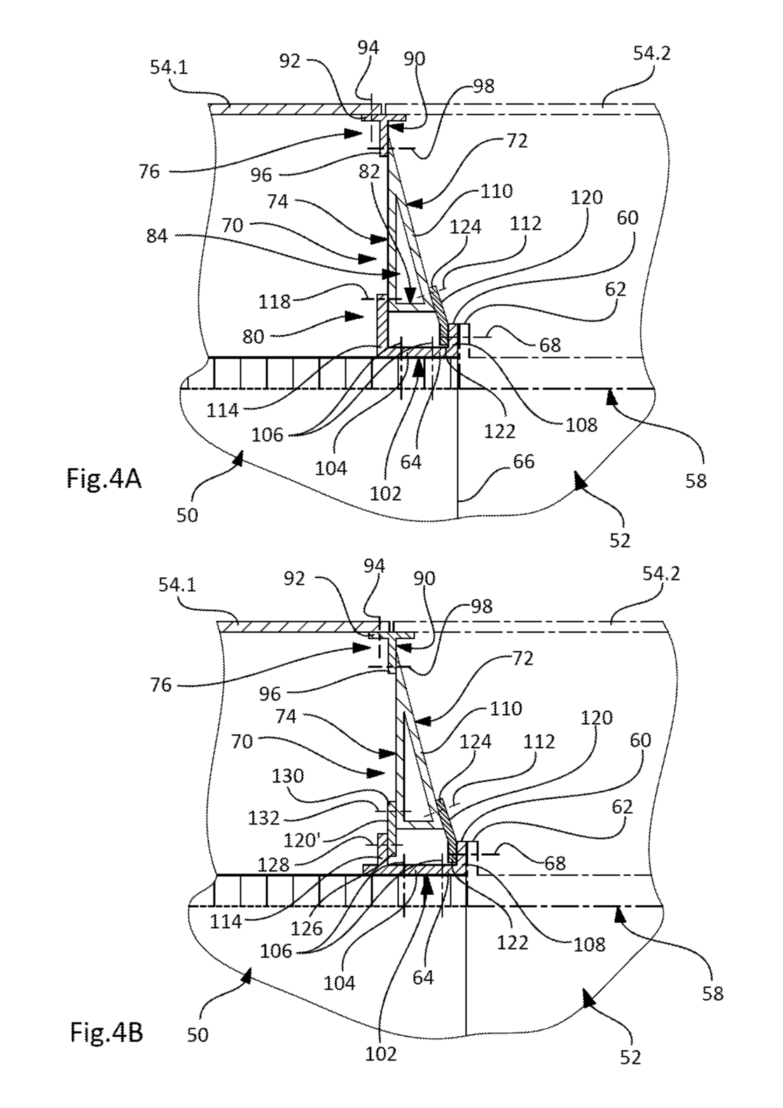

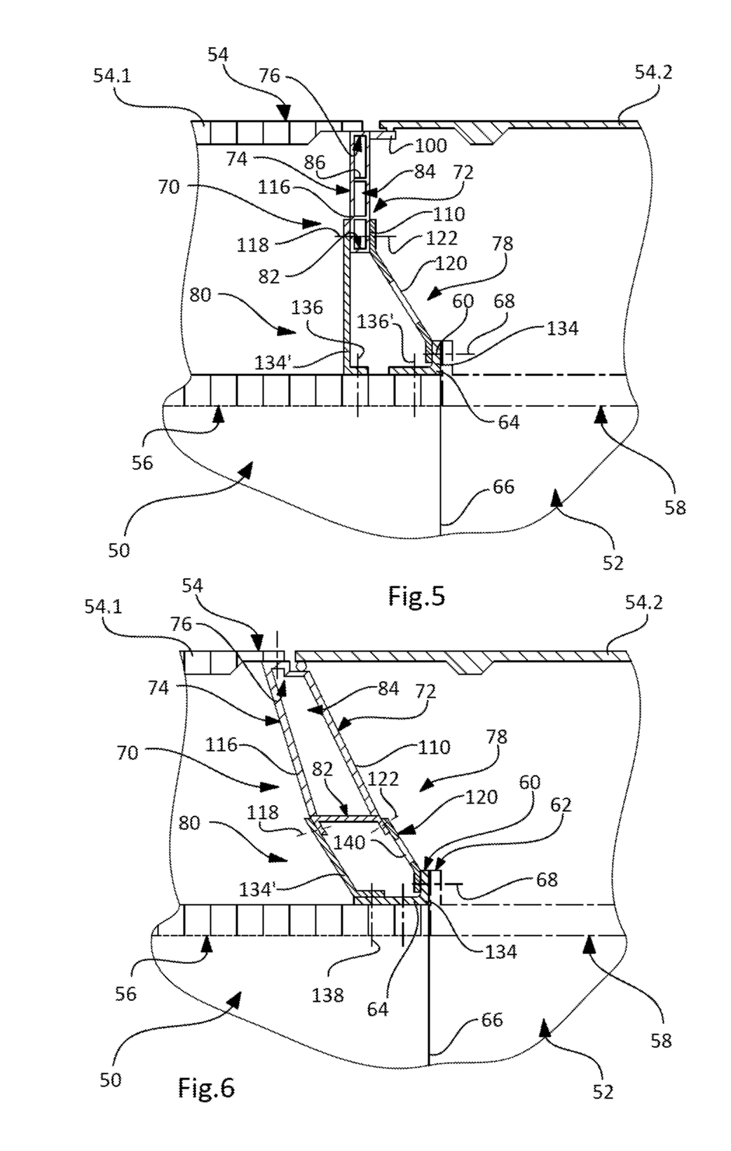

The rear frame 70 preferably comprises a hollow profile section 84 consisting of a portion of the first ring 72, a portion of the second ring 74 and the reinforcing element 82. This hollow profile section 84 has a rectangular cross section in accordance with certain variants shown in FIGS. 3A, 3B and 5, or a triangular cross section in accordance with certain variants shown in FIGS. 4A, 4B and 7. However, the hollow profile section 84 is not restricted to these cross sections and other more complex shapes are conceivable, as shown in FIG. 6.

Advantageously, the hollow profile section 84 extends over the entire circumference of the inner duct, or only over certain angular sectors.

According to one embodiment, the hollow profile section comprises means for improving its compressive strength in a longitudinal direction. Thus, the hollow profile section 84 can comprise one or more stiffener(s) 86 parallel to the reinforcing element 82 as shown in FIGS. 3B and 5, or comprise a cellular structure 88 whose walls are parallel to the reinforcing element 82 as shown in FIGS. 4B and 7.

Advantageously, the cross section of this hollow profile section 84 is constant over the entire circumference of the nacelle, meaning that the properties of the rear frame 70 are the same over the entire circumference of the nacelle. A hollow profile section can comprise a single length or several lengths arranged end-to-end and connected to each other.

Depending on the case, the hollow profile section 84 can be connected directly or indirectly to the outer wall 54.

When the hollow profile section 84 is connected directly to the outer wall 54 (as in FIGS. 3A, 3B, 5, 6 and 7), the connection 76 comprises a series of rivets or bolts distributed over the circumference of the outer wall 54.

When the hollow profile section 84 is connected indirectly to the outer wall 54 (as in FIGS. 4A and 4B), the connection 76 comprises an interposed part 90, for example a T-shaped part, a first portion 92 of the interposed part 90 being connected to the outer wall 54 by a series of rivets or bolts 94, a second portion 96 of the interposed part 90 being connected to the hollow profile section 84 by a series of rivets or bolts 98.

As shown in FIGS. 5, 6 and 7, the hollow profile section 84 and/or the interposed part 90 may comprise shapes 100 which are designed to receive the edge of a panel 54.2 which can be moved.

According to one preferred embodiment, the hollow profile section 84 is made of composite material.

Advantageously, the hollow profile section 84 is connected to the inner duct 56 and to the annular flange 60 via at least one bracket which takes on the role of the connections 78 and 80.

According to certain variants shown in FIGS. 3A, 3B, 4A, 4B and 7, the rear frame 70 comprises a U-shaped bracket 102, the base of the U 104 being connected to the inner duct 56 by connecting elements 106, a first branch of the U 108, acting as annular flange 60, being connected on one hand to the means of propulsion by means of the connecting elements 68 and on the other hand to a first face 110 of the hollow profile section 84 by means of connecting elements 112, a second branch of the U 114 being connected to a second face 116 of the hollow profile section 84 by means of connecting elements 118.

As with the connecting elements 68, the connecting elements 106, 112 and 118 can be rivets or bolts.

These variants are more particularly suited to the hollow profile sections 84 having a rectangular cross section.

According to other variants shown in FIGS. 4A, 4B and 7, at least one web 120 can be interposed between at least one branch of the U and the hollow profile.

According to variants shown in FIGS. 4A and 7, a web 120 is interposed between the first branch of the U 108 of the bracket and the first face 110 of the hollow profile section 84. In this case, the inner edge 122 of the web 120 is connected to the first branch of the U 108 by the connecting elements 68 and the outer edge 124 of the web is connected to the first face 110 of the hollow profile section by means of connecting elements 112.

According to one variant shown in FIG. 4B, as previously a web 120 is interposed between the first branch 108 of the bracket and the first face 110 of the profile section 108. In addition, a web 120′ is interposed between the second branch 114 of the bracket and the second face 116 of the profile section. In this case, the inner edge 126 of the web 120′ is connected to the second branch of the U 114 by connecting elements 128 and the outer edge 130 of the web 120′ is connected to the second face 116 of the hollow profile section by means of connecting elements 132.

According to other variants shown in FIGS. 5 and 6, the U-shaped bracket is replaced by two L-shaped brackets 134 and 134′. A first L-shaped bracket is connected to the inner duct 56. It is also connected on one hand to the means of propulsion by means of the connecting elements 68, so as to fulfil the role of the annular flange 60, and on the other hand to a first face 110 of the hollow profile section 84 by means of connecting elements 112. A second L-shaped bracket 134′ is connected to the inner duct 56 and to a second face 116 of the hollow profile section 84 by means of connecting elements 118. As previously, a web 120 can extend from at least one of the branches of the L-shaped brackets.

According to a variant shown in FIG. 6, the connecting elements 136 providing the connection between a first L-shaped bracket 134 and the inner duct 56 are different to the connecting elements 136′ providing the connection between the second L-shaped bracket 134′ and the inner duct 56.

According to another variant shown in FIG. 6, the two L-shaped brackets 134 and 134′ can have elements in common 138 for connecting to the inner duct.

The brackets and the webs can be made of metal or of composite material.

Each of them can be manufactured as a single part or as several angular sectors arranged end-to-end and connected to each other.

According to one preferred embodiment, at least one bracket or at least one web comprises openings 140 making it possible to install the connecting elements.

1. An aircraft nacelle comprising:
an air intake, connected to a means of propulsion, defining a longitudinal direction,
an outer wall,
an inner duct comprising an annular flange connected, by a plurality of connecting elements, to the means of propulsion,
a forward frame and a rear frame connecting the outer wall and the inner duct,
wherein the rear frame comprises a first ring and a second ring, in longitudinal planes, said rings comprising a first connection to the outer wall, the first ring comprising a second connection with the annular flange, the second ring comprising a third connection with the inner duct, which third connection is remote from the second connection.

2. The aircraft nacelle according to claim 1, wherein the rear frame comprises a reinforcing element connecting the first and second rings and maintaining the separation between the first and second rings in the longitudinal direction, said reinforcing element being remote from the outer wall and from the inner duct.

3. The aircraft nacelle according to claim 1, wherein the first ring and the second ring are connected at the level of the outer wall.

4. The aircraft nacelle according to claim 2, wherein the reinforcing element is parallel to the longitudinal direction.

5. The aircraft nacelle according to one of claim 2, wherein the rear frame comprises a hollow profile section consisting of a portion of the first ring, a portion of the second ring and the reinforcing element.

6. The aircraft nacelle according to claim 5, wherein the hollow profile section comprises means for strengthening the hollow profile in the longitudinal direction.

7. The aircraft nacelle according to claim 6, wherein the hollow profile section comprises a cellular structure whose walls are parallel to the reinforcing element.

8. The aircraft nacelle according to claim 5, wherein the rear frame comprises at least one bracket so as to connect the hollow profile section on one hand to the inner duct and on the other hand to the annular flange.

9. The aircraft nacelle according to claim 8, wherein the rear frame comprises a U-shaped bracket, the base of the U being connected to the inner duct, a first branch of the U, acting as annular flange, being connected on one hand to the means of propulsion and on the other hand to a first face of the hollow profile section, a second branch of the U being connected to a second face of the hollow profile section.

10. The aircraft nacelle according to claim 9, wherein the rear frame comprises at least one web interposed between at least one branch of the bracket and the hollow profile.

11. The aircraft nacelle according to claim 10, further comprising a web interposed between the first branch of the bracket and the first face of the hollow profile section.

12. The aircraft nacelle according to claim 11, further comprising a web interposed between the second branch of the bracket and the second face of the profile section.

13. The aircraft nacelle according to claim 8, wherein the rear frame comprises a first L-shaped bracket connected to the inner duct, to the means of propulsion and to a first face of the hollow profile section and a second L-shaped bracket connected to the inner duct and to a second face of the hollow profile section.

14. The aircraft nacelle according to claim 13, wherein the rear frame comprises at least one web interposed between at least one L-shaped bracket and the hollow profile.

15. The aircraft nacelle according to claim 13, wherein the two L-shaped brackets have elements in common for connecting to the inner duct.
